(19) United States
(12) Patent Application Publication
(10) Pub. No.: US 2006/0289523 A1
(43) Pub. Date: Dec. 28, 2006

(54) SOLDER PROCESS SYSTEM

(76) Inventor: Neeraj Saxena, Murray Hill, NJ (US)

Correspondence Address: BOC, INC., 575 MOUNTAIN AVE, MURRAY HILL, NJ, 07974-2064, US

(21) Appl. No.: 11/425,014

(22) Filed: Jun. 19, 2006

Related U.S. Application Data
(60) Provisional application No. 60/692,375, filed on Jun. 21, 2005.

(51) Int. Cl. H05B 6/80

(52) U.S. Cl. 219/731

(57) ABSTRACT

A system for solder processing includes a heating zone at a first pressure; a cooling zone at a second pressure higher than the first pressure, the heating and cooling zones in communication with each other and adapted for receiving a component to be soldered; and an outlet in communication with the heating zone for exhausting atmosphere from the heating zone and enabling a flow of gas from the cooling zone to the heating zone.

### BACKGROUND OF THE INVENTION

The present invention relates to methods and apparatus for treating objects and other work pieces with solder.

It is known in the industry to use separate and discrete processing chambers with variable atmospheres for heating and/or cooling of the components or parts that are to be soldered treated. The application of a vacuum during the processing in known systems can be useful during the heating or melting stage since such a vacuum substantially reduces, if not eliminates, voids which may form during the soldering process. It is known that drawing a vacuum during the cooling stage of the solder processing does not impact as much the actual processing of the solder.

Known systems rely upon the processing environment or chambers to be “sealed from the environment”, that is, sealed off from an environment external to the processing chambers where the effect of heating and cooling is undertaken on the component to be processed with solder.

Hydrogen (H₂) vacuum soldering is known and known systems employ separate, discrete chambers (with independent atmospheres) for heating and cooling of the parts to be soldered; in effect using separate atmospheres for heating and cooling. While providing a vacuum is generally useful during the heating or melting stage of the process, as such heating/melting reduces the number of voids formed during soldering, a vacuum is not as necessary during cooling and in fact provides little benefit.

Accordingly, the known systems require an extensive infrastructure in order to affect solder processing; in that the known systems rely upon separate and discrete processing chambers restricted from communication with each other for affecting the solder environment in which solder processing of a component may be undertaken.

### DETAILED DESCRIPTION OF THE DRAWINGS

For a more complete understanding of the present invention, reference may be had to the following drawings taken in conjunction with the detailed description, of which:

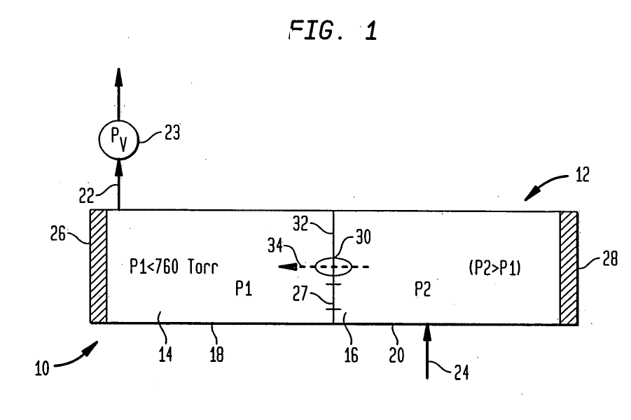

FIG. 1 shows an embodiment of the solder process system of the invention; and

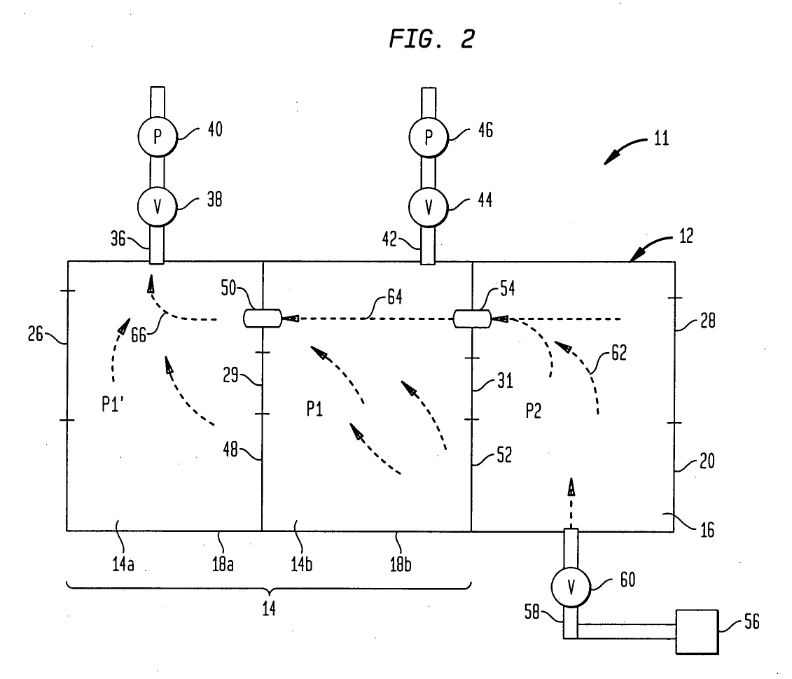

FIG. 2 shows another embodiment of the solder process system of the invention.

### DESCRIPTION OF THE INVENTION

As shown in FIG. 1, the solder process system of the present invention is generally indicated at 10 and includes housing 12 having a heating/melting zone 14 and a cooling zone 16. A system 11 at FIG. 2 shows the heating zone 14 divided into a preheat zone 14a and a melting zone 14b. The heating/melting zone 14 may be referred to herein as the heating zone 14.

Each of the heating/melting zone 14 and the cooling zone 16 may be provided in a corresponding one of the heating chamber 18 (18a, 18b), and cooling chamber 20, respectively, for the atmosphere employed in that particular chamber.

As shown in FIG. 1, a conduit 22 with a passage is in communication with the heating chamber 18 and hence the heating zone 14. A conduit 24 with a passage is in communication with the cooling chamber 20 and hence the cooling zone 16 for providing hydrogen, nitrogen (N₂) or combinations thereof, thereto. The chambers 18, 20 are segregated from the external environment by the housing 12 and movable doors 26, 28.

The conduit 22 may include a pump 23 or pump and valve assembly to be actuated in order to promote heating in said zone for processing of the component with solder. The conduits 22, 24 regulate the gas flow to and from the chambers 18, 20, and the gas flow can be controlled by butterfly or other valving means.

There is also provided a wall 32 or baffle disposed in the housing 12 to separate the heating and cooling chambers 18, 20, respectively. The wall 32 is constructed with a valve 30 or other flow or pressure regulator means in the wall. Door 27 is formed at the wall 32 to enable the component to be moved between the chambers 14, 16. The valve 30 enables communication between the chambers 18, 20. The doors 26, 27, 28 permit movement of the solder component through the apparatus 10.

A pressure “P2” of the cooling zone 16 is preferably greater then a pressure “P1” of the heating zone. By way of example and not by way of limitation, P1 may be less than or equal to 760 Torr.

Operation of the system includes opening the conduit 22 a sufficient amount during processing to facilitate drawing down of the atmosphere to a vacuum in the heating zone 14 to facilitate environmental conditions for heat processing of the solder to the component. Similarly, ingress of the gas at the conduit 24 into the cooling zone 16 is permitted to subsequently flow, as indicated by the arrow 34, through the regulator valve 30 or valve means into the heating zone 14 where it may subsequently be withdrawn through the conduit 22. Such a construction and arrangement of the components of the system 10 of the present invention provides for a uniform controlled flow of gas from one zone to another zone, i.e. from the cooling zone 16 as indicated by the arrow 34 through to the heating zone 14, whereupon it can flow or be exhausted to the external atmosphere. In effect, the heating and cooling chambers 18, 20 are permitted to be in controlled communication with each other and the atmosphere external to the housing 12.

The construction of this embodiment of the present invention is cost effective, in that there is only one exhaust pump which may be required for one of the chambers, as opposed to a plurality of pumps being in communication with each of the chambers. In addition, cooling is more cost effective by providing the cooling gas (hydrogen, nitrogen or combinations thereof) at a higher pressure in the cooling zone 16 to provide a more thorough and quick cooling process for control thereof. In addition, the higher pressure P2 causes the cooling gas to move though the valve 30 with no complicated mechanical activity.

Operation of the system can be strictly controlled regarding the amount of exhaust at the conduit 22 and the flow setting or restriction of the valve 30 between the two chambers 18, 20, in order to selectively manipulate both the pressures P1, P2 and the temperature at the heating chamber 18.

Another reason for the higher pressure P2 in the cooling zone 16 is to substantially reduce if not eliminate any introduction of evaporated flux from the melt zone 14 into the cooling zone 16 where detrimental effects, such as flux condensation on the component, could occur with respect to the soldered component and thereby reduce the effectiveness of cooling in the cooling chamber 20. To further this, the valve 30 is preferably a one-way valve. The valve 30 may also be two-way, but controllable with respect to the direction of flow required between the chambers 18, 20.

Another embodiment of the present invention is shown generally at 11 in FIG. 2, and includes at least three (3) chambers, wherein the heating zone 14 would be segregated into a preheat zone 14a (preheat chamber 18a) and a melt zone 14b (melt chamber 18b). In such construction, where the system 11 has both the preheat zone 14a and the melt zone 14b, it is preferred to have a respective pump in communication with a respective one of the preheat and melt chambers as shown in FIG. 2.

Referring to FIG. 2, a pipe 36 is in communication with the preheat zone 14a. The pipe 36 includes a valve 38 and pump 40 in communication to coact with the pipe 36. The pipe 36 provides for communication between and among the chamber 14a and an external atmosphere.

A pipe 42 is in communication with the melt chamber 14b to provide for communication between the chamber 14b and the external atmosphere. A valve 44 and pump 46 are in communication with the pipe 42 for coaction therewith.

There is also provided a wall 48 or baffle disposed in the housing 12 to separate the pre-heat chamber 14a from the melt chamber 14b. A valve 50 or flow regulator means is disposed in the wall 48 to control the flow of the atmosphere between and among the chambers 18a, 18b. Door 29 is provided at the wall 48 to enable the component to move between the chambers 14a, 14b.

A wall 52 is disposed in the housing 12 to separate the melt chamber 14b from the cooling zone 16 of the cooling chamber 20. A valve 54 or flow regulating means is disposed in the wall 52 to control communication between and among the chambers 18b, 20, to thereby control the flow of the atmosphere between and among said zones 14b, 16. Door 31 is provided at the wall 52 to enable the component to move between the chambers 18b, 20.

The doors 26, 28 control ingress and egress of the components into and out of the apparatus 11 and seal the apparatus 11 from the external environment.

A source 56 of hydrogen, nitrogen or combination thereof, is provided to the cooling chamber 20 via pipe 58 to the cooling zone 16. Pump 60 is provided at the pipe 58 or conduit to transfer the gas from the source 56 to the chamber 20.

The embodiment of FIG. 2 prevents flux that has melted or evaporated in the melt zone 14b from ingress into the preheat zone 14a, and similarly prevents vapors from the flux melt into the preheat zone 14a. The wall or baffle 48 separating the preheat zone 14a from the zone 14b is not necessarily as critical as the wall 52 that is provided separating the heating zone 14b from the cooling zone 16. The wall 52 and valve 54, in combination with the higher pressure P2 at the cooling chamber 20, prevents unwanted vapors and flux particulate from escaping from the heat zone 14 (14a, 14b) to the cooling zone 16.

Pressure P2 is greater that pressure P1. Pressure P1 is greater that pressure P1′. Other cooling gases from the sources 24, 56 may be used as necessary. Arrow 62 in FIG. 2 shows gas flow at the cooling zone 16. Arrow 64 in FIG. 2 shows a flow of the cooling gas originating from the source 56 transiting through the zone 14b. Arrow 66 shows gas flow at the chamber 14a to the conduit 36. Filters (not shown) may also be disposed in the valves 30, 50, 54, to remove unwanted matter from the air flow through said valves.

In summary, with a dual chamber system such as in FIG. 1, only one exhaust pump is necessary in communication with the melt zone; while in the system of FIG. 2 employing a melt chamber with a preheat chamber it is preferred to have an exhaust pump in communication with each of the respective preheat and melt chambers.

It will be understood that the embodiments described herein are merely exemplary and that a person skilled in the art may make many variations and modifications without departing from the spirit and scope of the invention. All such variations and modifications are intended to be included within the scope of the invention as defined in the appended claims. The embodiments described above are not only in the alternative, but can be combined.

What is claimed is:

1. A system for solder processing a component, comprising a heating zone at a first pressure; a cooling zone at a second pressure higher than the first pressure, the heating and cooling zones in communication with each other and adapted for receiving the component to be processed; and outlet means in communication with the heating zone for exhausting atmosphere from the heating zone.

2. The system according to claim 1, further comprising a wall separating the heating zone and the cooling zone; and a valve disposed in the wall for providing the communication between the heating zone and the cooling zone.

3. The system according to claim 1, wherein the cooling zone comprises a cooling gas.

4. The system according to claim 3, wherein the cooling gas is selected from the group consisting of hydrogen, nitrogen, and combinations thereof.

5. The system according to claim 1, wherein the outlet means is constructed and arranged to draw a vacuum at the heating zone.

6. The system according to claim 1, wherein the outlet means comprises a pump and valve assembly.

7. The system according to claim 2, further comprising a passage in the wall, the passage sized and shaped for the component to pass therethrough.

8. The system according to claim 1, wherein the first pressure is less than 760 Torr.

9. The system according to claim 1, further comprising a preheat zone in communication with the heating zone; wherein at least one of the preheat zone and the heating zone are provided with the outlet means.

10. The system according to claim 9, further comprising a wall separating the preheat zone and the heating zone; and a valve disposed in the wall for providing communication between the preheat zone and the heating zone.

11. A process for treatment of a component to be soldered, comprising introducing the component into a first zone having a first pressure for heating the component; introducing the component into a second zone having a second pressure not less than the first pressure for cooling the component; providing a flow of cooling gas from the second zone to the first zone; and exhausting a select amount of atmosphere from the first zone.

12. The process according to claim 11, further comprising preheating the component before introducing the component to the first zone.

13. The process according to claim 11, wherein the second pressure is greater than the first pressure.

14. The process according to claim 11, further comprising controlling the flow of cooling gas from the second zone to the first zone.

15. The process according to claim 11, wherein the exhausting a select amount of the atmosphere is to provide a vacuum at the first zone.
